(19) United States
(12) Patent Application Publication
(10) Pub. No.: US 2006/0169893 A1
(43) Pub. Date: Aug. 3, 2006

(54) X-ray photoelectron spectroscopy

(75) Inventors: Jae-cheol Lee, Suwon-si (KR); Chang-bin Lim, Seoul (KR); Jin-hak Choi, Suwon-si (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Electronic Co., Ltd., Suwon-si (KR)

(21) Appl. No.: 11/254,862

(22) Filed: Oct. 21, 2005

(30) Foreign Application Priority Data
Feb. 1, 2005 (KR) 10-2005-0009106

(51) Int. Cl. H01J 49/44

(52) U.S. Cl. 250/305; 250/306

(57) ABSTRACT

An X-ray photoelectron spectroscopy includes an X-ray generator generating an X-ray, a collimator collimating the X-ray generated in the X-ray generator, a monochromator for converting the collimated X-ray into a single wavelength X-ray and reflecting the single wavelength X-ray to a test sample, the monochromator being installed to be displaceable and rotatable in response to an irradiating direction of the X-ray, an analysis chamber in which the test sample is disposed, the analysis chamber being installed to be rotatable in response to the displacement of the monochromator so as to allow the single wavelength to be accurately irradiated to the test sample, an energy analyzer for measuring kinetic energy of an electron that is emitted from the test sample by the single wavelength X-ray, and an electron detector for detecting an electron passing to the energy analyzer.

### CROSS-REFERENCE TO RELATED PATENT APPLICATION

This application claims the benefit of Korean Patent Application No. 10-2005-0009106, filed on Feb. 1, 2005, in the Korean Intellectual Property Office, the disclosure of which is incorporated herein in its entirety by reference.

### BACKGROUND OF THE DISCLOSURE

1. Field of the Disclosure

The present disclosure relates to an X-ray photoelectron spectroscopy (XPS), and more particularly, to an XPS that can be used for performing an absorption spectroscopic analysis as well as a photoelectron spectroscopic analysis by varying X-ray energy irradiated to a test sample.

2. Description of the Related Art

An X-ray Photoelectron Spectroscopy (XPS) or an Electron Spectroscopy for Chemical Analysis (ESCA) is a photoelectron spectroscopic analysis method for detecting photoelectrons emitted by light. The photoelectron spectroscopic analysis may be further classified according to light source into the XPS and an UV photoelectron spectroscopy (UPS).

According to photoelectric effect theory, maximum kinetic energy E_{k,max} of a photoelectron emitted from metal can be calculated according to the following equation.
E_{k,max}=hυ−E_{φ}−E_{b}
where, Hυ is light energy emitted, E_{b} is binding energy of electrons, and E_{φ} is a function of the metal.

However, no method for accurately measuring the kinetic energy of the photoelectron has been proposed.

In the 1950's, Siegbhn et al. developed a β-spectroscopy having a high analysis capability to measure the binding energy of inner shell electrons of atoms. It has been noted that the binding energy of the electrons is varied when the chemical state of an element is varied. This fact has been used in studying an electron structure of a solid or gas.

The XPS is a non-destructive, non-radiant transition. The emitted electrons have a mean free path according to kinetic energy in the metal. The mean free path of the electrons emitted from the metal or metal oxide is short (5-50 Å), and it can be noted that the electrons are emitted from a surface layer. That is, the electrons emitted from the surface layer provide information of the surface layer. An XPS spectrum provides the number of electrons introduced into a spectrometer by plotting the kinetic energy or binding energy of the electrons.

FIG. 1 shows a schematic view of a conventional XPS.

Referring to FIG. 1, a conventional XPS includes an X-ray generator 2, a monochromator 4 converting an X-ray generated from the X-ray generator 2 into a single wavelength, a chamber 7 in which a test sample is disposed, an energy analyzer 8 detecting energy of electrons generated from the test sample, and a detector 9 detecting the amount of the electrons emitted from the test sample. However, since no means for varying the X-ray energy irradiated to the test sample is provided in the conventional XPS, an X-ray absorption spectroscopic (XAS) analysis cannot be obtained in conventional XPS. Furthermore, since Mg K_{α1,2}(1253.6 eV) and Al K_{α1,2}(1486.6 eV) that generate a soft X-ray are used as a light source, it is difficult to analyze the electron structure of a K-cell for most of the elements except for the light elements. In addition, since a probe depth of the test sample is limited to 5 nm from a surface of the test sample, information on the chemical state of a portion deeper than 5 nm cannot be obtained. Therefore, the conventional XPS is mainly used to detect photo and auger electrons, which are emitted from the test sample by X-ray irradiation. Only the XPS spectrum or an auger electron spectroscopy (AES) spectrum can be obtained. That is, no XAS spectrum is obtained.

### SUMMARY OF THE DISCLOSURE

The present invention may provide an XPS that can be used for performing an absorption spectroscopic analysis as well as a photoelectron spectroscopic analysis by varying X-ray energy irradiated to a test sample.

According to an aspect of the present invention, there may be provided an X-ray photoelectron spectroscopy including an X-ray generator generating an X-ray; a collimator collimating the X-ray generated in the X-ray generator; a monochromator for converting the collimated X-ray into a single wavelength X-ray and reflecting the single wavelength X-ray to a test sample, the monochromator being installed to be displaceable and rotatable in response to an irradiating direction of the X-ray; an analysis chamber in which the test sample is disposed, the analysis chamber being installed to be rotatable in response to the displacement of the monochromator so as to allow the single wavelength to be accurately irradiated to the test sample; an energy analyzer for measuring kinetic energy of an electron that is emitted from the test sample by the single wavelength X-ray; and an electron detector for detecting an electron passing to the energy analyzer.

The X-ray photoelectron spectroscopy may further include a total electron detector measuring a total yield of the electrons that are emitted from the test sample by the single wavelength X-ray.

The X-ray photoelectron spectroscopy may further include a linear guide along which the monochromator is displaced in response to the irradiating direction of the X-ray.

The X-ray photoelectron spectroscopy may further include first and second bellows tubes respectively disposed between the collimator and the monochromator and between the monochromator and the analysis chamber to isolate the advancing path of the X-ray from an outer space.

The first and second bellows tubes maintain a vacuum state. The X-ray generated by the X-ray generator has an energy range of 0.542 keV.

According to the present XPS, by controlling the distance L from the X-ray generator to the monochromator, the X-ray energy irradiated to the test sample can be varied. Accordingly, a specific X-ray spectrum according to the energy variation can be effectively obtained from a test sample. The variation of the X-ray energy allows both the X-ray photoelectron spectroscopic analysis and the X-ray absorption spectroscopic analysis to be realized.

### BRIEF DESCRIPTION OF THE DRAWINGS

The above and other features and advantages of the present invention will are described in detail in exemplary embodiments thereof with reference to the attached drawings in which:

FIG. 1 is a schematic view of a conventional XPS;

FIG. 2 is a schematic view of an XPS according to an embodiment of the present invention;

FIG. 3 is a graph illustrating a continuous X-ray spectrum of Mo according to energy variation by an XPS of the present invention;

FIG. 4 is a graph illustrating a high energy AES spectrum, which is obtained from a Ti plate using an XPS of the present invention;

FIG. 5 is a graph illustrating an X-ray absorption near edge structure (XANES) spectrum of an Mn K-edge, which is obtained from KMnO₂ using an XPS of the present invention; and

FIG. 6 is a graph illustrating an XANES spectrum of Al K-edge, which is obtained from Al₂O₃ using an XPS of the present invention.

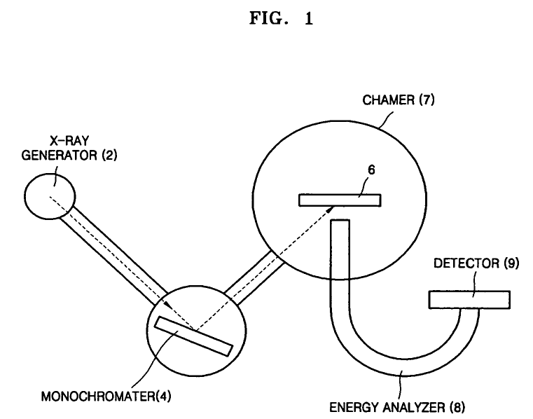

### DETAILED DESCRIPTION OF EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will fully convey the concept of the invention to those skilled in the art.

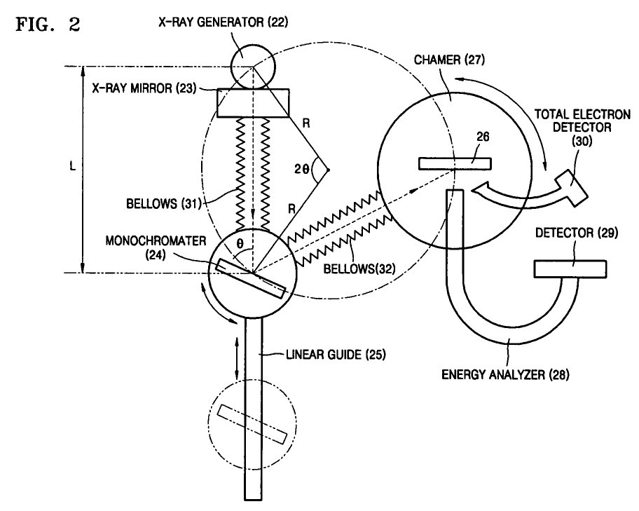

FIG. 2 shows a schematic view of an XPS according to an embodiment of the present invention.

Referring to FIG. 2, the inventive XPS includes an X-ray generator 22, a collimator 23, a monochromator 24 installed to be displaceable and rotatable according to an irradiating direction of an X-ray, an analysis chamber 27 installed to be rotatable, an energy analyzer 28, and an electron detector 29.

The X-ray generator 22 is for generating the X-ray. That is, a filament is heated to emit thermions. When the emitted thermions collide on an X-ray generation source material, the X-ray is generated from the source material. A variety of conventional anode materials may be used as the source material. That is, the source material may be formed of one or more materials selected from the group consisting of Mg K_{α1,2}(1253.6 eV), Al K_{α1,2}(1486.6 eV), Mo, W, Ag, Au, Cu and Cr. The X-ray generator 22 may be designed to generate the X-ray having an energy range of 0.5-42 keV.

The collimator 23 is an X-ray mirror functioning to collimate the X-ray generated from the X-ray generator 22. Therefore, the divergent X-ray is collimated to be converted into a parallel X-ray.

The monochromator 24 converts the collimated X-ray into a single wavelength X-ray and reflects the X-ray toward a test sample 26. Since the X-ray further includes K_{α3}, K_{α4}, K_{α5}, K_{β2} in addition to K_{α1} and K_{α2}, the photoelectron spectrum becomes complex. Therefore, only an X-ray having a specific wavelength may be selected among incident X-rays having a continuous wavelength. According to a feature of the present invention, the monochromator 24 is designed to be displaceable and rotatable according to the irradiating direction of the X-ray. For example, the monochromator 25 is installed on a linear guide 25 disposed along the irradiating direction of the X-ray to be displaceable along the linear guide 25. Furthermore, in order to allow the single wavelength X-ray to be irradiated to the test sample 26, the monochromator 24 is designed to be rotatable at each location in response to the displacement thereof.

According to another feature of the present invention, the analysis chamber 27 is designed to be rotatable. The test sample is disposed in the analysis chamber 27. In order to allow the single wavelength X-ray to be irradiated to the test sample 26, the analysis chamber 27 is designed to rotate in response to the location movement of the monochromator 24. In order to easily detect electrons emitted from the test sample 26 by the irradiated X-ray, the analysis chamber 27 is preferably designed to keep the vacuum state.

The energy analyzer 28 measures kinetic energy of electrons such as auger electrons and photoelectrons that are emitted from the test sample 26 by the single length X-ray. A retarding field grid analyzer (RFA), a cylindrical mirror analyzer (CMA), and a concentric hemispherical analyzer have been widely used as the energy analyzer 28. For example, the CHA is comprised of two concentric hemispheres. When the electron is introduced between the concentric hemispheres, the path of the electron is varied by a negative potential applied to the outer concentric hemisphere.

The electron detector 29 is provided for detecting the electron passing the energy analyzer 28. A channeltron that is well known in the art may be used as the electron detector 29. The channeltron is formed of a glass tube that is trumpet-shaped and twisted spirally. An inner wall of the glass tube is coated with a high resistance material. When a voltage is applied to the opposite end of the glass tub, it becomes a continuous dynode to amplify the electron. A multi-channel plate may be also used as the electron detector 29.

According to a feature of the above-described inventive XPS, the X-ray energy may be irradiated in a varied manner to the test sample by controlling an incident angle of the X-ray and a distance from the X-ray generator to the monochromator. Therefore, the inventive XPS performs both the photoelectron spectroscopic analysis and the absorption spectroscopic analysis.

This will be described in more detail hereinafter.

Energy can be generally represented by the following Equation 1.

$$E = hv = \frac{hc}{λ} \qquad Equation 1$$

In addition, Braggs' law can be represented by the following Equation 2.
nλ=2d sin θ Equation 2

Using Equations 1 and 2, the following Equation 3 can be obtained.
2d sin θ=n12.296/E Equation 3

where, θ can be represented as a function of energy E. Therefore, the variation of the X-ray energy irradiated to the test sample means that the variation of a Braggs' angle θ.

In the inventive XPS, the locations of the X-ray generator 22 and the analysis chamber 27 are fixed while the location of the monochromator 24 is displaceable according to the irradiating direction of the X-ray. Therefore, a Rowland circle passing the X-ray generator, test sample and monochromator 22, 26 and 24 can be determined. When a radius of the Rowland circle is R, the following Equation 4 can be obtained from a geometrical arrangement relationship of the X-ray generator, test sample and monochromator 22, 26 and 24.
L=2R sin θ Equation 4

where, L is a distance from the X-ray generator 22 to the monochromator 24, θ is an angle defined between the monochromator 24 and the incident X-ray. Therefore, it can be noted from Equation 4 that the angle θ can be varied by varying the distance L. As the angle θ is varied, the X-ray energy irradiated to the test sample can be varied. That is, by varying the length L from the X-ray generator 22 to the monochromator 24, the X-ray energy irradiated to the test sample can be varied.

In the present XPS, since the monochromator 24 is designed to be displaceable and rotatable according to the irradiating direction of the X-ray, the distance L can be varied. The analysis chamber 27 is designed to be rotatable in response to the displacement of the monochromator 24 so that the X-ray reflected from the monochromator 24 can be irradiated to the test sample 26 disposed in the analysis chamber 27.

According to the above-described XPS, by controlling the distance L from the X-ray generator to the monochromator, the X-ray energy irradiated to the test sample can be varied. Accordingly, a specific X-ray spectrum according to the energy variation can be effectively obtained from the test sample and both the X-ray photoelectron spectroscopic analysis and the X-ray absorption spectroscopic analysis can be realized. By the X-ray absorption spectroscopic analysis, an extended X-ray absorption fine structure (EXAFS) spectrum and an X-ray absorption near edge structure (XANES) spectrum can be obtained.

Preferably, the inventive XPS may further include a total electron detector 30 measuring a total yield of the electrons emitted from the test sample. The total electron detector 30 is designed to detect all types of electrons such as photo, auger and secondary electrons that are emitted from the test samples.

In order to isolate the advancing path of the X-ray from an outer space, first and second bellows tubes 31 and 32 may be respectively disposed between the collimator 23 and the monochromator 24 and between the monochromator 24 and the analysis chamber 27. In order to prevent the X-ray from scattering in the advancing path, it is preferable that the first and second bellows tube 31 and 32 maintain a vacuum state.

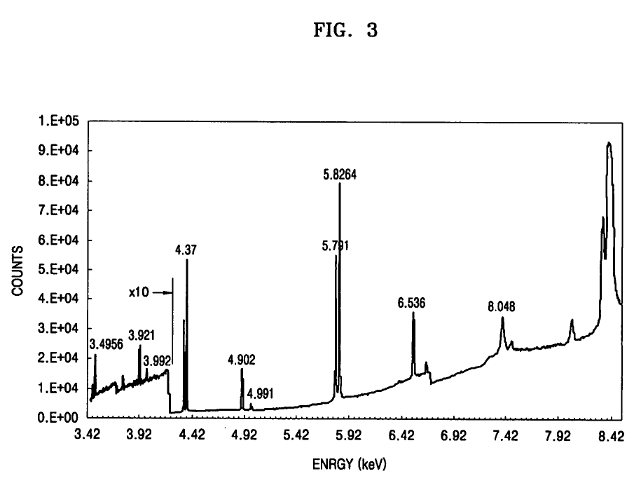

FIG. 3 shows a graph illustrating a continuous X-ray spectrum of Mo according to energy variation by an XPS of the present invention.

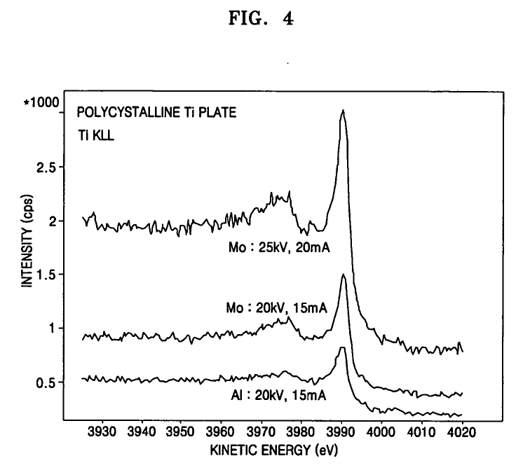

FIG. 4 shows a graph illustrating a high energy AES spectrum, which is obtained from a Ti plate using an XPS of the present invention.

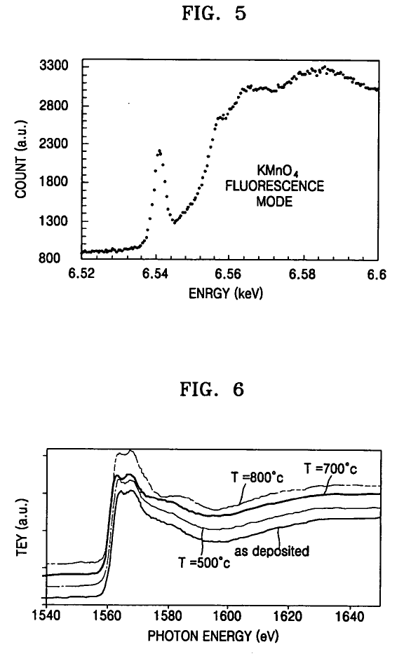

FIG. 5 shows a graph illustrating an X-ray absorption near edge structure (XANES) spectrum of an Mn K-edge, which is obtained from KMnO₂ using an XPS of the present invention.

FIG. 6 shows a graph illustrating an XANES spectrum of Al K-edge, which is obtained from Al₂O₃ using an XPS of the present invention.

According to the above-described inventive XPS, by controlling the distance L from the X-ray generator to the monochromator, the X-ray energy irradiated to the test sample can be varied. Accordingly, a specific X-ray spectrum according to the energy variation can be effectively obtained from a test sample. The variation of the X-ray energy allows both the X-ray photoelectron spectroscopic analysis and the X-ray absorption spectroscopic analysis to be realized.

Furthermore, in the present XPS, a variety of X-ray source materials such as Mo, W, Ag, Au, Cu, and Cr in addition to Mg K_{α1,2}(1253.6 eV) and Al K_{α1,2}(1486.6 eV) can be utilized. The energy range of the generated X-ray is sufficiently large (0.5-42 keV). Therefore, although it is impossible in the conventional XPS to analyze the electron structure of the K-cell for most of the elements except for the light elements, the present XPS makes it possible to analyze the electron structure of the K-cell for heavy elements as well as the light elements.

In the conventional XPS, since the probe depth of the test sample is limited to 5 nm, it is impossible to obtain information of the test sample at a portion deeper than 5 nm. However, in the present invention, it is possible to obtain the information of the test sample at a depth up to 20 nm.

The present XPS can be used for the non-destructive analysis of an interlayer in an organic electro-luminescence or for an electron structure analysis of a semiconductor interface.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An X-ray photoelectron spectroscopy comprising:
an X-ray generator generating an X-ray;
a collimator collimating the X-ray generated in the X-ray generator;
a monochromator for converting the collimated X-ray into a single wavelength X-ray and reflecting the single wavelength X-ray to a test sample, the monochromator being installed to be displaceable and rotatable in response to an irradiating direction of the X-ray;
an analysis chamber in which the test sample is disposed, the analysis chamber being installed to be rotatable in response to the displacement of the monochromator so as to allow the single wavelength to be accurately irradiated to the test sample;
an energy analyzer for measuring kinetic energy of an electron that is emitted from the test sample by the single wavelength X-ray; and
an electron detector for detecting an electron passing to the energy analyzer.

2. The X-ray photoelectron spectroscopy of claim 1, further comprising a total electron detector measuring a total yield of the electrons that are emitted from the test sample by the single wavelength X-ray.

3. The X-ray photoelectron spectroscopy of claim 1, further comprising a linear guide along which the monochromator is displaced in response to the irradiating direction of the X-ray.

4. The X-ray photoelectron spectroscopy of claim 1, further comprising first and second bellows tubes respectively disposed between the collimator and the monochromator and between the monochromator and the analysis chamber to isolate the advancing path of the X-ray from an outer space.

5. The X-ray photoelectron spectroscopy of claim 4, wherein the first and second bellows tubes maintain a vacuum state.

6. The X-ray photoelectron spectroscopy of claim 1, wherein the X-ray generated by the X-ray generator has an energy range of 0.5-42 kev.
